(19) United States
(12) Patent Application Publication
(10) Pub. No.: US 2002/0157992 A1
(43) Pub. Date: Oct. 31, 2002

(54) Alternating current magnetic separator

(76) Inventor: John R. McGaa, St. Paul, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/044,845

(22) Filed: Jan. 10, 2002

Related U.S. Application Data
(63) Continuation of application No. 09/243,267, filed on Feb. 3, 1999.
Application No. 09/243,267 is a continuation-in-part of application No. 08/707,124, filed on Sep. 3, 1996, now Pat. No. 5,868,255.

(51) Int. Cl. B03C 1/30

(52) U.S. Cl. 209/39; 209/214; 209/215; 209/223.1; 209/232; 209/590

(57) ABSTRACT

A magnetic ore purification system for enriching magnetic ore concentration in a feed material. The system includes an elutriator and at least one alternating current magnet. The system may also optionally have a device, which may be an ultrasonic transducer, for introducing vibrational energy into the elutriator, and a feedback control system. The elutriator has a feed port for introducing the feed material and an enriched port for collecting an enriched material having a magnetic ore concentration that is greater than the feed material. As the feed material passes between the feed port and the enriched port, the feed material is subjected to a low strength magnetic field generated by the alternating current magnet. The feed material may also be subjected to vibrational energy.

### CROSS-REFERENCE TO RELATED APPLICATION(S)

This application is a continuation in part of U.S. patent application Ser. No. 08/707,124 filed Sep. 3, 1996 which will issue into U.S. Pat. No. 5,868,255 on Feb. 9, 1999.

### BACKGROUND OF THE INVENTION

The present invention relates generally to a system for enriching magnetic ore concentration in a feed material. More particularly, the present invention relates to a magnetic separator for enriching magnetite concentration in iron ore.

As steelmaking processes become technologically more advanced, the raw materials used in the steelmaking processes are required to conform with more stringent standards. For example, “commodity grade” iron ore for use in conventional blast furnaces currently must have a gangue concentration of between 3 and 6 percent by weight, preferably 4 percent. However the trend is for blast furnaces to require cleaner and cleaner ores.

Direct-reduced-iron (DRI) processes are revolutionizing the global steel industry and are the driving force for new iron ore beneficiation technologies. Iron ore used in the newer DRI steelmaking processes must have a gangue concentration of 1 to 2 percent by weight. Currently DRI steelmakers are buying all of their ores from lower cost, higher grade foreign producers.

To attain a salable iron ore product, it is typically necessary to refine or “beneficiate” crude iron ore. The required degree of processing and the expense associated with the beneficiation process depends on the initial gangue level as well as the hardness of the iron ore. For example, the major type of domestic iron ore, “taconite” ore, requires a significant degree of processing because the gangue is intimately associated with the iron fraction, which is known as “magnetite.”

An initial step in the iron ore beneficiation process involves grinding the iron ore. Components in ground iron ore may be classified into three categories: free magnetite, middlings, and free silica. Middlings and free silica are collectively referred to as gangue.

Middlings, which are particles containing a mixture of magnetite and silica, are weakly magnetic and therefore are not readily separable from free magnetite by conventional magnetic separators. To remove or “liberate” the magnetite in middlings, the ore must be more finely ground to release more free magnetite. Alternatively, chemical additives must be used to cause the middlings to be separated by flotation.

Conventional iron ore beneficiation processes typically involve grinding the iron ore to between 80 and 90 percent by weight less than 45 microns, which liberates the bulk of the magnetite from gangue. Gangue may then be separated from magnetite using magnetic separation techniques.

While more finely grinding iron ore theoretically allows the iron ore to be enriched to a greater degree because a higher percentage of middlings are broken down into magnetite and gangue, fine grinding is prohibitively expensive.

The efficiency of conventional beneficiation processes decreases as the iron ore particle size decreases because competing hydrodynamic and inter-particle forces within the magnetic separator and in the flotation process cause magnetite to be entrained with the gangue and removed with it so that iron losses are significant. Efficiency of these conventional processes drops dramatically when ore is ground to a particle size of less than 10 microns.

Domestic iron ores which are enriched by prior art beneficiation processes relying solely on grinding and magnetic separation typically have gangue concentrations of between about 5 and 6 percent by weight, which makes the iron ore undesirable for use in many steelmaking processes because it produces too much slag in the blast furnace. Blast furnace operators prefer 4 percent gangue because it produces the optimal amount of slag.

To achieve the 4 percent gangue concentration target, a secondary refining process known as “silica floatation” is typically used where middlings are problematic. Silica floatation processes require chemical reagents to be mixed with the iron ore. While silica floatation processes enable the gangue concentration target to be met, the use of chemical reagents significantly increases the cost of the beneficiation process and creates chemical-laden mineral processing waste. The chemical reagents also necessitate that effluent generated from the floatation process be treated before the effluent is disposed of or reused.

Subjecting an iron ore slurry to a preliminary ultrasound treatment and then separating the iron ore slurry with a magnetic separator is described by Rychov et al. in Effect of Ultrasonic Treatment of Magnetite Slurry on the Indicators of Magnetic Enrichment. Rychov et al. indicates that this preliminary treatment allows the iron ore level in the iron ore concentrate to be increased by 1.13 percent. The maximum iron concentration produced during Rychov et al.'s studies was 64.84 percent. Pure magnetic iron ore has an iron concentration of 72 percent, which indicates a gangue content in excess of 5 percent in Rychov's studies.

In an article entitled Magnetic Separation in Alternating Fields, Goodluck et al. discusses using an alternating current high gradient magnetic separator. Goodluck et el. indicates that the alternating current magnet was operated at 550 volts and 60 hertz so that a field of 600 gauss was generated by the magnet.

Goodluck et al. describes enriching an iron ore slurry by passing the iron ore slurry through a cylindrical canister having an inner diameter of 3.8 centimeters. The cylindrical canister was packed with a stack of wire mesh pieces that were arranged to form a matrix. In one configuration, Goodluck et al. describes that the matrix had a length of 3 centimeters and that the wire mesh had a diamond shaped hole of 4 millimeters by 2 millimeters. Goodluck et al. further indicates that mechanically vibrating the separator increases the enrichment of the iron ore.

Applicant's invention provides an ore beneficiation process which overcomes the limitations and shortcomings of the prior art by effectively rejecting weakly magnetic middlings and readily producing enriched iron ore with gangue contents that meet the requirements of either blast furnace or DRI steelmaking specifications, without excessive iron losses or use of chemicals.

### BRIEF SUMMARY OF THE INVENTION

The present invention includes a magnetic ore purification system for enriching magnetic ore concentration in a feed material. The system includes an elutriator and at least one alternating current magnet. The system may also optionally have a device for introducing vibrational energy into the elutriator. The device may be at least one ultrasonic transducer for introducing vibrational energy in the ultrasonic range. The system may also have a feedback control system for controlling the flow of material through the elutriator. The elutriator has a feed port for introducing the feed material and an enriched port for collecting an enriched material having a magnetic ore concentration that is greater than the feed material. Feed material flows in a substantially countercurrent direction to water which is introduced into the elutriator through a water feed port.

As the feed material passes between the feed port and the enriched port, the feed material is subjected to a low strength magnetic field generated by the alternating current magnet. The feed material may also be subjected to vibrational energy.

The features, benefits and objects of this invention will become clear to those skilled in the art by reference to the following description, claims and drawings.

### BRIEF DESCRIPTION OF THE DRAWINGS

FIG. 1 is a diagrammatical view of a separator according to the present invention.

FIG. 1a is a diagrammatical view of an alternate embodiment of the lower portion of the separator showing how water can be diffused into the separator.

FIG. 1b is a diagrammatical view of another alternate embodiment of the lower portion of the separator showing how water can be diffused into the separator.

FIG. 2 is a diagrammatical view of another embodiment of the separator.

FIG. 3 is a diagrammatical view of a separator control system that controls the input material.

FIG. 4 is a diagrammatical view of a separator control system that controls the output material.

FIG. 5 is a diagrammatical view of an alternate embodiment of the present invention.

### DETAILED DESCRIPTION

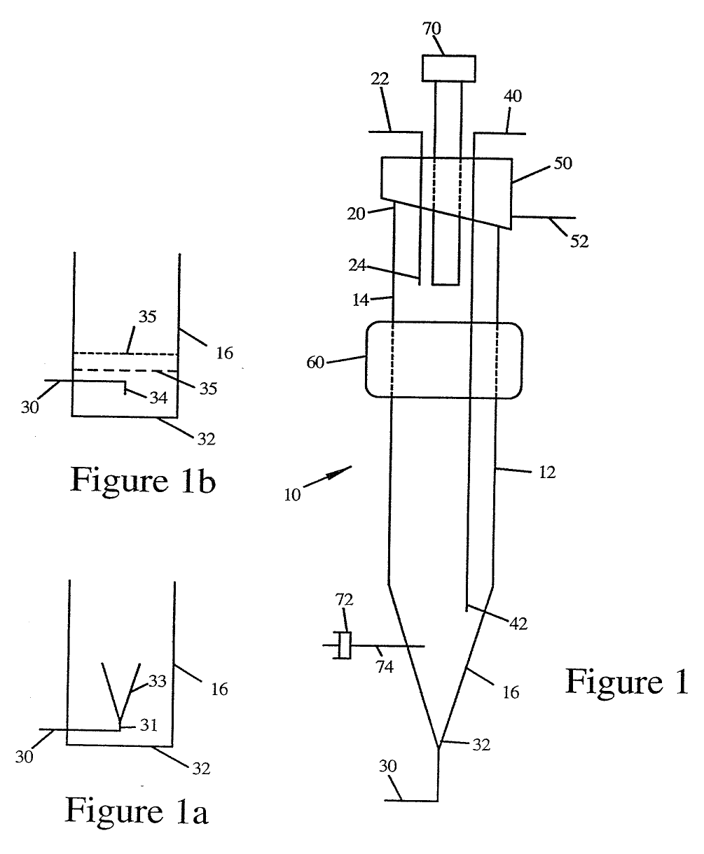

The present invention is a magnetic ore separator, as most clearly illustrated at 10 in FIG. 1. Using the separator in conjunction with the method of the present invention allows a high purity iron ore concentrate to be produced without the use of silica floatation or the addition of chemical reagents.

As used herein, the term “iron ore concentrate” means that the iron ore concentrate has a gangue concentration of less than 5 percent by weight. The term “ultra-pure iron ore concentrate” means that the iron ore concentrate has a gangue concentration of less than approximately 2 percent by weight. All references to concentration in this application are percent by weight unless identified otherwise.

The separator 10 and process of the present invention further enable a high percentage of the magnetite in the input iron ore material to be recovered in the output iron ore concentrate. As used herein, the term “high percentage” means that recovery of magnetite in the output material is greater than 90 percent of the input material. More preferably, the recovery of magnetite in the iron ore concentrate is greater than 95 percent.

While prior art iron ore enrichment processes rely on chemical dispersants and high flow rates to enhance the separation of gangue from magnetite, the present invention separates magnetite from gangue using alternating current magnetic fields, or a combination of alternating current magnetic fields and vibrational energy. Using the present invention, it is possible to produce iron ore concentrates and ultra-pure iron ore concentrates while achieving high percentage magnetite recovery levels because the present invention does not experience the decrease in efficiency as the particle size of the iron ore is decreased. Rather, the efficiency of the present invention increases as the particle size decreases. The uniform low strength magnetic field of the invention allows the fine highly-magnetic magnetite particles to be recovered while the fine less-magnetic middlings are rejected by the separator. By uniform low strength magnetic field is meant that the magnetic field strength through the coil is not localized such as in the case of a permanent magnet.

Referring to FIG. 1, the magnetic separator 10 includes an elutriator 12 that is preferably oriented in a substantially vertical orientation. The elutriator 12 preferably has a substantially cylindrical main body portion 14 and a substantially conical lower portion 16 that extends from the main body portion 14. The conical shape of portion 16 facilitates fluid flow upward with minimum turbulence and eddies. While the elutriator 12 is illustrated as having a cylindrical main body portion 14 and conical lower portion 16, a person of ordinary skill in the art will appreciate that other configurations may be used without departing from the scope of the present invention.

The elutriator 12 is fabricated out of a non-magnetizable material so that the elutriator 12 does not interfere with the magnetic field inside of the elutriator 12. Examples of suitable materials for fabricating the elutriator 12 include plastic, fiberglass, glass and stainless steel.

Proximate to an upper end 20 of the elutriator 12, a feed line 22 is provided for introducing an iron ore material into the elutriator 12. A lower end 24 of the iron ore material feed line 22 preferably extends into the main body portion 14 and is preferably adjustable so that the position of end 24 may be raised or lowered.

The elutriator 12 also preferably includes a water feed line 30, which is preferably located proximate to a lower end 32 of the elutriator 12. Positioning the water feed line 30 at an opposite end of the elutriator 12 from the iron ore material feed line 22 allows the elutriator 12 to be operated in a countercurrent manner, meaning that water moves generally upward, and iron ore material moves generally downward against the flow of water.

Referring to FIG. 1a and 1b , if the lower portion 16 of the elutriator 12 is not conical, fluid turbulence can alternatively be minimized by diffusing the flow of water from water feed line 30 as it enters the elutriator 12. FIG. 1a shows diffusion accomplished by a redirecting element 31 at the end of water feed line 30 and a conical shaped diffuser 33 which directs water upward. FIG. 1b shows diffusion accomplished by a redirecting element 34 at the end of water feed line 30 which directs the flow of water downward where it impinges on the lower end 32 of the elutriator 12 and then flows upward through grates or screens 35.

The elutriator 12 also includes a collection line 40 for collecting iron ore concentrate. An end 42 of the iron ore concentrate collection line 40 preferably extends into the vicinity of the juncture between lower portion 16 and main body portion 14. The iron ore concentrate line 40 is preferably adjustable so that a height of the end 42 may be varied to optimize the purity of the iron ore concentrate as well as the recovery of magnetite in the iron ore concentrate.

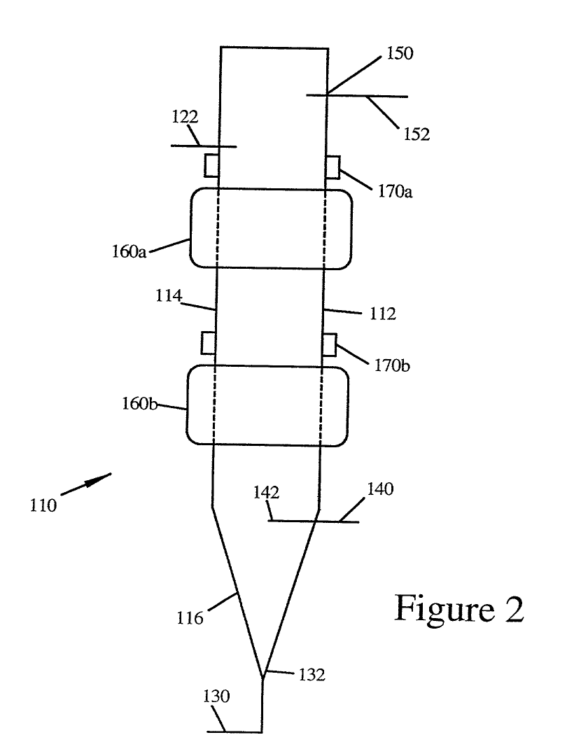

In the embodiment shown in FIG. 1, the collection line 40 extends downwardly from the upper end 20 of the elutriator 12. This configuration minimizes the number of penetrations through the elutriator 12, which enhances the reliability of the separator 10. Alternatively, as shown in FIG. 2, a collection line (port) 140 may penetrate generally horizontally into the elutriator.

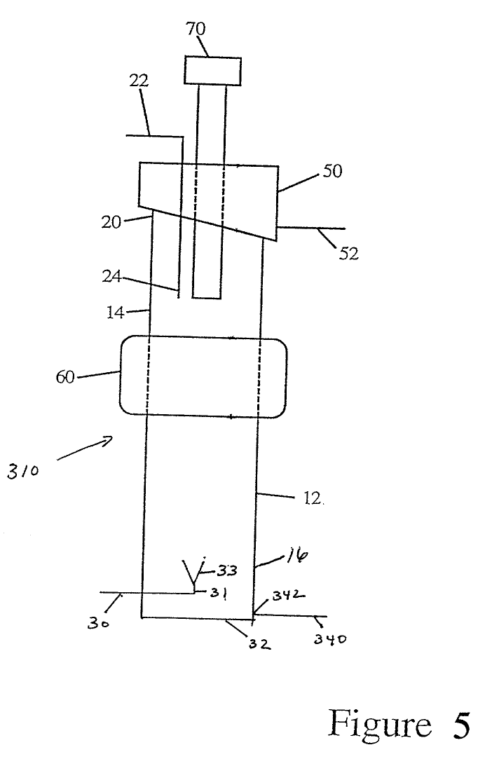

An alternate embodiment generally indicated at 310 is illustrated in FIG. 5. In FIG. 5, like reference characters are used to indicate like elements that were discussed in relation to FIGS. 1, 1a and 1b. In the alternate embodiment illustrated in FIG. 5, a collection line 340 for collecting iron ore concentrate is positioned through port 342 at a horizontal level that is below that of the water feed line 30. This configuration works for elutriators that do not have a conical shaped lower portion 16. As water flows out of diffuser 33 and upward, the area outside of and below diffuser 33 has water that is not moving in countercurrent flow with the iron ore concentrate. Iron ore concentrate that sinks into that area will compact more. If no port 342 existed in that area, the area would have stagnant water and would fill up with iron ore concentrate in the form of a dense mud. By placing the collection port 342 below the level of the water feed line 30, some of the water fed in is diverted directly to the collection port 342 thereby keeping the area outside and below the diffuser from filling up with iron ore mud.

Locating port 342 below the level of water feed line 30 also provides an advantage of producing iron ore concentrate output material with higher solids content than if the port for the collection line were in a location in the countercurrent flow such as shown in FIG. 1. With the outlet port in a location such as in FIG. 1, the solids content of the output material is approximately 25 percent. With the outlet port in a location such as shown in FIG. 5, the solids content can be approximately 40 percent. Water must be removed from the output material in a subsequent processing step, so the higher solids content can reduce the effort and cost needed in that step. If the solids content gets too high however, it becomes too difficult to pump the material through processing lines.

Port 342 and collection line 340 may be proximate the lower end 32 of elutriator 12 as shown in FIG. 5, or if the elutriator has a substantially longer portion below the water feed line 30, port 342 may be substantially below the level of the water feed line but not proximate the lower end 32 of elutriator 12. As the iron ore concentrate sinks further below the water feed line level, the material compacts more. This may provide for selectively varying, the solids content of the output material by means such as a plurality of collection ports at varying distances below the level of the water feed line, or a variable height collection line inside of elutriator 12.

Proximate to the upper end 20, the elutriator 12 preferably includes a collection area 50, such as a trough, for collecting a waste mixture that is generated by the separation process. The waste mixture is preferably directed from the area 50 to a water reclamation process or disposal facility using a waste collection line 52. Alternatively, as shown in FIG. 2, a waste collection line (port) 150 may penetrate generally horizontally into the elutriator near its top.

The separator 10 also includes a magnet 60 that extends around a portion of the main body portion 14 of elutriator 12. The magnet 60 used with the present invention is preferably an alternating current (AC) coil magnet that provides a uniform low strength magnetic field over a large volume. Using an alternating current magnet decreases inter-particle frictional forces that hinder countercurrent flow of magnetic and non-magnetic particles.

The intensity of the magnetic field is preferably adjustable by varying the voltage in the magnetic coil. Alternatively, the number of turns in the coil could be varied. The alternating current magnet 60 is preferably operated at a frequency of 60 hertz, which corresponds with the frequency of conventional electrical distribution systems. The alternating current magnet could be operated at a lower frequency such as 20 hertz which may be more beneficial for recovering larger size magnetite particles, or at a higher frequency, such as 100 hertz, which may be more beneficial for recovering smaller size magnetite particles.

The separator 10 of the present invention may also include a device for introducing vibrational energy into the elutriator 12. It is well known that vibrational energy helps heavy particles settle out of a slurry. Vibrational energy also introduces dispersion forces in the magnetic zone of the elutriator 12. When magnetite particles are within the magnetic zone of the elutriator 12, they inadvertently entrap some gangue. The vibrational energy enhances the dispersion, which helps gangue to be freed.

The intensity of the vibrational energy imparted into the elutriator 12 is preferably variable. The intensity of the vibrational energy is preferably selected to optimize dispersion so that beneficiation is enhanced without losing product from excessive vibrational energy.

Vibrational energy may be introduced into the elutriator by an actuator 72, such as a piston or diaphragm type actuator, in fluid communication with the fluid in the elutriator through vibration line 74. As actuator 72 is cycled, fluid is cycled back and forth in line 74, which creates pressure waves in the fluid in the elutriator. A mechanical vibrator, such as those used for concrete, may also be used to introduce vibrational energy into the elutriator by inserting it into the elutriator.

Mechanical vibrators typically operate at low frequencies, under 100 hertz. Pneumatic and hydraulic actuators can achieve higher frequencies, but their efficiency drops as the frequency increases.

High frequency, such as ultrasonic (20,000 hertz) vibrational energy can be introduced into the elutriator 12 very efficiently with an ultrasonic transducer 70. The number and size of the ultrasonic transducers 70 that are used in conjunction with the present invention are selected based on the size of the elutriator 12 and the flow rates in which the separator 10 will be operated. While FIG. 1 illustrates the ultrasonic transducer 70 extending into the elutriator, the ultrasonic transducer may also be positioned around an outside surface of the elutriator 12 as illustrated in FIG. 2.

The ultrasonic energy vibrates and breaks up agglomerations of small particles and allows the gangue trapped in them to escape and be flushed away by the water. It has been found that the effect of ultrasonic energy is most pronounced in smaller size particles where electrostatic agglomeration and magnetic flocculation prevent conventional separation techniques from being effective.

Ultrasound penetration within the elutriator is improved and dampening effects from the magnetic field are reduced due to the diffuse and dynamic nature of the magnetic field produced by the alternating current magnet 60. While it is possible to use a permanent magnet or a DC magnet, which typically produces a localized, relatively high-strength field, in combination with ultrasonic energy, alternating current magnets typically produce superior results.

The combination of alternating current magnetism, gravity, and fluid viscosity with optional vibrational energy allows both high grade and high recovery to be achieved simultaneously while not requiring the use of chemicals or multi-step processing.

In operation, the iron ore material is preferably ground to finer than 80 percent less than 325 mesh prior to processing with the method of the present invention. Such finely ground ore is conventionally referred to as “finisher feed”. Water is introduced into the elutriator 12 through water feed line 30, and iron ore material is introduced into the elutriator 12 through the iron ore material feed line 22 so that the iron ore material and water flow through the elutriator 12 in countercurrent directions. To reject middlings, the water feed rate is preferably selected so that the water rises between three and six feet per minute, optimally between four arid five feet per minute, in the empty elutriator 12. The iron ore material feed rate is selected so that the desired residence time of the material in the elutriator achieves the target gangue content while also maximizing production capacity. The average residence time to clean iron ore is between one and twenty minutes, preferably between five and fifteen minutes. A person of ordinary skill in the art will appreciate that the particular flow rate and residence time needed to obtain a desired recovery rate and grade depend on a variety of factors, such as the shape of the elutriator and the grade and grind of iron ore fed into the elutriator 12.

As the iron ore material passes through the elutriator 12, iron ore material is simultaneously subjected to the forces of magnetism, gravity, fluid viscosity, and optionally vibrational energy. The magnetic field produces mutual forces of attraction between magnetite particles, which causes the magnetite to coalesce into “particulate strings”. The string phenomenon is a significant part of the separation process as it arranges the magnetic particles in a geometry that minimizes their resistance to the upward water flow.

Gravitational forces cause the particulate strings to move downwardly against the fluid forces exerted by the upwardly flowing water until the particulate strings drop out of the magnetic zone. The particulate strings continue moving downwardly until the particulate strings are collected through the lower end 42 of the iron ore concentrate line 40.

The vertical position of lower end 42 of the iron ore concentrate line 40 is adjusted to optimize the purity of the iron ore concentrate as well as the recovery of magnetite in the iron ore concentrate. As noted above, the iron ore concentrate preferably has a gangue concentration of less than about 5 percent and the magnetite recovery is preferably greater than 95 percent. The iron ore concentrate is generally referred to as an enriched material.

The upward flow of the water causes the gangue to be separated from the magnetite and move upwardly. This mixture of gangue is generally referred to as a waste mixture. The waste mixture is moved upwardly until it passes out of the elutriator 12 and into the waste collection area 50. At this point, the waste material is directed to a water reclamation facility or is disposed of using appropriate mechanisms.

Referring to FIG. 2, in another embodiment, the separator 110 includes an elutriator 112 with a substantially cylindrical main body portion 114 and a substantially conical lower portion 116 that extends from a lower end of the main body portion 114 as in FIG. 1. But to provide greater control and increased capacity of the separation process, the separator 110 includes an upper alternating current magnet 160a and a lower alternating current magnet 160b. In this embodiment, the amperage in the upper alternating current magnet 160a changes with the level of magnetic material in the elutriator 12, while the amperage in the lower alternating current magnet 160b is constant since it always filled with magnetic material. The varying amperage of the upper alternating current magnet 160a allows control of the separation process based upon variations of the iron ore material feed rate and discharge rate.

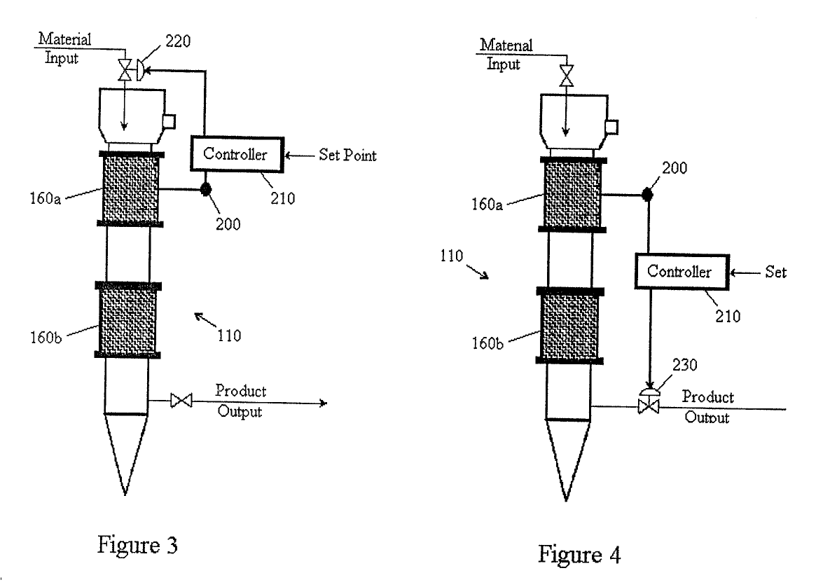

Referring to FIGS. 3 and 4, the separation process is preferably controlled by controlling the input material feed rate, the product output rate, or both. During operation the elutriator 112 is full of water and iron ore material. During steady state operation where water is constantly flowing upward, ore material is being input at the top and enriched material is being removed at the bottom, an upper level to the iron ore material in the elutriator exists. Above that level water and gangue are removed form the elutriator. For maximum efficieny of the process, the upper level of the iron ore material should be within the magnetic zone of the upper magnet 160a, preferably near the top of that zone. Electromagnets are more efficient with a magnetic material as a core, so when the magnetic zone of the upper magnet is full of iron ore material, the amperage draw in the upper magnet 160a is minimal. Conversely, when there is no magnetic material in the magnetic region, the amperage draw is at a maximum. For example, in the case of an elutriator rated at ten tons per hour, the amperage in the upper magnet varies between approximately 85 amps when the level of the iron ore material is below the magnet, and approximately 60 amps when the level of the iron ore material is above the magnet. The upper level of the iron ore material is optimized when the amperage in the upper magnet is between 65 and 70 amps. The amperage in the lower magnet is a constant 60 amps because it is always filled with iron ore.

This phenomenon can be used to control the level of iron ore material in the elutriator by monitoring the amperage used by the upper magnet 160a with an amperage sensor 200 and using a controller 210, such as a PID set point controller, in a feedback loop to control either an input regulating device 220, such as a valve or variable speed pump, to regulate the flow of iron ore material fed into the elutriator, an output device 230, such as a valve or variable speed pump, to regulate the flow of enriched product removed for the elutriator, or both valves. FIG. 3 illustrates such a control of the input regulating device 220, and FIG. 4 illustrates such control of the output regulating device 230. By controlling both devices, it is possible to increase or decrease the average residence time of iron ore in the elutriator by respectively decreasing or increasing the flow rates from both devices, while still maintaining the desired level of iron ore in the elutriator 112.

Alternatively, the level of iron ore material in the elutriator can be controlled by using a separate sensor, such as a density detector, level detector, or an optical sensor to detect the iron ore level so that it is maintained just slightly above the upper magnet, but below the waste port 150, thereby allow the upper magnet to be run at minimum amperage and allowing the separator 110 to be run at maximum capacity without iron ore level rising so high that it flushes out with the gangue.

For maximum energy efficiency, the electrical system powering the alternating current magnets preferably is tuned with capacitors to minimize amperage draw of the separator 10.

The embodiment shown in FIG. 2 is designed for higher iron ore concentrate production rates, such as fifty tons per hour. As magnetite coalesces into strings at the upper magnet, it sinks through the upwardly moving water. When the strings sink below the magnetic region proximate to the upper magnet, they partially disperse, thereby releasing some additional gangue which had been trapped in the string formation. The sink rate for partially dispersed magnetite is not as fast as for the strings, but the partially dispersed magnetite does continue to sink until it reaches the lower magnet were it again coalesces into strings which accelerates its sinking. Below the lower magnet, the strings again partially disperse and may release some more gangue. At this point the enriched material is collected. Further below the lower magnet, the magnetic field is sufficiently low that the enriched material is fully dispersed and will no longer settle in the elutriator. If the length of the elutriator is such that the lower portion 116 is excessively below the second magnet, the enriched material will not reach the collection port 140.

While it is possible to construct an embodiment of this invention having more than two sequential magnetic areas, the added height required for such an elutriator would require greater water pressures, necessitating stronger components in the system. Also the residence time provided by two magnets is typically sufficient to meet the target gangue content and production capacity. However, for very large production rates and lower gangue targets, elutraitors having more than two sequential magnetic areas may be needed to meet the required residence time.

The iron ore material is preferably introduced into the elutriator through an iron ore feed port 122 preferably located above upper magnet 160a and below waste port 150. As shown in FIG. 2, iron ore feed port 122 may penetrate generally horizontally into elutriator 112. Water is introduced into the elutriator 112 through a water feed port 130 that is located at a lower end of the lower portion 116.

FIG. 2 also shows an alternate configuration for an enriched material collection port 140, penetrating generally horizontally into elutriator 112. The port 140 is preferably located proximate to where the main body portion 114 and the lower portion 116 intersect. The position of collection port 140 may be fixed for a desired purity and recovery, or it may be adjustable. Characteristics of the iron ore concentrate collected may be varied by changing the height of the end 142 in port 140. For example, moving the end 142 downward allows a higher purity iron ore concentrate to be collected while moving the end 142 upward reduces the water concentration in the iron ore concentrate. A 20-50% solids content is desirable in the output concentrate for handling purposes. Adjustment of the collection port position may be by means such as a plurality of apertures in elutriator 112 into which a collection port may selectively be placed, a plurality of permanently mounted collection ports which may be selectively used to collect material, or a collection port having a feature such as a bend or curve, that allows rotation of the port to change the position of its end 142. End 142 may alternatively have a vertical portion that telescopes to vary its height. The iron ore feed port 122 may similarly be adjustable to vary its height.

Waste material is expelled through the waste port 150 at an upper end of the elutriator 112. Waste material is then directed through a waste collection line 152 to water collection process or to a disposal unit.

Vibrational energy may be introduced into the elutriator of this embodiment similarly as is shown in FIG. 1. For introducing ultrasonic vibrational energy, the separator 10 may include an upper ultrasonic transducer 170a and a lower transducer 170b to provide adequate agitation of the iron ore material passing through the elutriator 112. The upper ultrasonic transducer is preferably attached to the outside of the elutriator 112 above the upper alternating current magnet 160a. The lower ultrasonic transducer 170b is preferably attached to the elutriator 112 between the upper alternating current magnet 160a and the lower alternating current magnet 160b. These locations correspond to the areas where the bulk of the gangue is separated from the magnetite.

A person of ordinary skill in the art will appreciate that the utility of the present invention extends beyond using the separator and process of the present invention for enriching the magnetite concentration in iron ore. The concepts of the present invention are also suitable for separating other types of magnetic materials, such as upgrading difficult-to-separate minerals and in the treatment of certain oils and heavy metal contaminated wastes.

The dimensions of the main body portion and the conical lower portion of the elutriator are selected based upon the desired operating capacity of the elutriator. When the elutriator is designed to produce iron ore concentrate at a rate of approximately 100 pounds per hour, having a volume of approximately 2 gallons, the diameter and length of the main body portion are 4 inches and 48 inches respectively, and the conical lower portion is approximately 18 inches long. When the elutriator is designed to produce iron ore concentrate at a rate of approximately 10 tons per hour, having a volume of approximately 450 gallons, the diameter and length of the main body portion are 2 feet and 20 feet respectively, and the conical lower portion is approximately 4 feet long.

The alternating current magnets are also sized for the desired operating capacity of the elutriator. For the 100-pounds-per-hour unit with the above dimensions, each of the magnets weighs approximately 25 pounds and is formed from approximately 1360 feet of wire. Each of the magnets was operated at approximately 120 volts and between about 4 and 6 amperes to produce a magnetic field of between 100 and 200 gauss.

The iron ore material feed rate for the 100-pounds-per-hour unit with the above dimensions is preferably about 1 liter per minute of feed slurry and the water feed rate is preferably about 8-14 liters per minute.

The iron ore material feed rate for the ten-ton-per-hour unit is preferably about 40-80 gallons per minute at 30-40 percent solids and the water feed rate is preferably 150-250 gallons per minute. The above conditions work well with Minnesota iron ores; it should be noted that iron ores have differing magnetic susceptibility, i.e. are more readily magnetized, and therefore respond differently to water feed rates, residence times, and magnet strength.

The 100-pounds-per-hour size elutriator described above was used in the following examples. The first example, run in a batch mode, studied the effect of particle size on the ability and speed to reject liberated gangue. The second example, also run batch mode, studied the effect of ultrasonic energy on the purity of the recovered enriched iron ore material. These examples are not intended to limit the scope of the present invention.

### EXAMPLE 1

To examine the effects of the iron ore particle size on ability and speed to reject liberated gangue, the iron ore was ground to three particle sizes. The first iron ore material was finisher feed having a particle size of about 80 percent less than 325 mesh. A second iron ore material had a particle size of about 90 percent less than 400 mesh, and it was made by subjecting the finisher feed to a 5 minute grind process. A third iron ore material had a particle size of about 98 percent less than 500 mesh, and it was made by subjecting the finisher feed to a 15 minute grind process. Each of the iron ore material samples had an initial gangue concentration of approximately 11.5 percent.

A quantity of iron ore material was introduced into the 100-pounds-per-hour elutriator described previously through a feed line located proximate to the upper end of the elutriator. Water was introduced through a lower end of the elutriator at a rate of approximately 8 liters per minute. Samples were pulled from the collection line every minute from one to nine minutes.

The gangue rejection rates of the iron ore concentrate for each of the residence times are set forth in Table 1. The magnetite recovery at each of the residence times was greater than 90 percent. The residence time needed to reject approximately 90 percent of the liberated gangue in the iron ore material for the first, second, and third iron ore particle sizes were approximately 5, 3, and 2 minutes, respectively. The data illustrates that the finer the grind, the less residence time required to reject a given amount of liberated gangue. The data also illustrates that given sufficient time in the elutriator, all but about 1% of liberated gangue can be rejected by an elutriator and process of the present invention regardless of the particle size.

TABLE 1

Liberated Gangue Rejection (% Weight)

| Residence Time | 80 percent | 90 percent | 98 percent |
|---|---|---|---|
| (minutes) | 325 mesh | 400 mesh | 500 mesh |
| 1 | 50 | 74 | 79 |
| 2 | 74 | 88 | 94 |
| 3 | 82 | 92 | 95 |
| 4 | 87 | 94 | 96 |
| 5 | 90 | 95 | 97 |
| 6 | 92 | 96 | 98 |
| 7 | 95 | 98 | 98 |
| 8 | 96 | 98 | 99 |
| 9 | 98 | 99 | 99 |

### EXAMPLE 2

To determine the effect of ultrasonic energy on the purity of the recovered enriched iron ore material, variations in ultrasound intensity were used with the 100-pound-per-hour elutriator used in Example 1. The iron ore material used for each of the trials had a particle size of approximately 80 percent less than 325 mesh. An ultrasonic transducer was inserted into the elutriator through the upper end as illustrated in FIG. 1. The ultrasonic transducer was manufactured by sonics and Materials of Danbury, Conn., under the designation VibraCell 600. Three levels of ultrasound were introduced into the elutriator during these trials: no ultrasound, low ultrasound, and high ultrasound. The low ultrasound had an intensity of approximately 75 watts and the high ultrasound had an intensity of approximately 150 watts. The average iron ore material residence time in the elutriator was selected at either 2, 4, 10, 15, or 20 minutes.

The gangue concentration was measured for each of the iron ore concentrates obtained during these trials. The magnetite recovery for each of the trails was greater than 90 percent. The results of these trials are set forth in Table 2. The gangue concentration decreased for each of the ultrasound intensities as the residence time increased. The gangue concentration also decreased for each residence time as the level of ultrasound was increased.

The elutriator and process of the present invention produced superior results to prior art processes without the need to use chemical flocculation agents.

TABLE 2

| | Gangue Concentration in | | |
|---|---|---|---|
| | Recovered Material (% Weight) | | |
| Residence Time | No | Low | High |
| (minutes) | Ultrasound | Ultrasound | Ultrasound |
| 2 | 6.3 | 6.2 | 5.7 |
| 4 | 5.6 | 5.5 | 4.8 |
| 10 | 5.5 | 5.1 | 4.1 |
| 15 | 5.4 | 4.9 | n/a |
| 20 | 5.1 | 4.5 | 3.7 |

Although the present invention has been described with reference to preferred embodiments, workers skilled in the art will recognize that changes may be made in form and detail, without departing from the spirit and scope of the invention.

1. A magnetic ore purification system for enriching a concentration of magnetic ore in a feed material, the system comprising:
an elutriator having a feed material port for introducing a feed material into the elutriator and an enriched material port for collecting an enriched material from the elutriator, wherein the enriched material has a magnetic ore concentration that is greater than the concentration of magnetic ore in the feed material; and
at least a first alternating current magnet for producing at least one low strength magnetic field in the elutriator; and
wherein the system is capable of producing enriched material with a magnetic ore concentration of greater than about 95 percent by weight.

2. The magnetic ore purification system of claim 1, and further comprising a water feed port for introducing water into the elutriator.

3. The magnetic ore purification system of claim 2, wherein the feed material port is opposite the water feed port so that the feed material and water flow through the elutriator in substantially countercurrent directions.

4. The magnetic ore purification system of claim 1, and further including a second alternating current magnet disposed in spaced axial relationship from the first alternating current magnet.

5. The magnetic ore purification system of claim 1, wherein the feed material in the elutriator has a level, and further comprising a process control system that includes at least one sensor for detecting the level, at least one control mechanism for regulating flow of material through the elutriator, and feedback control between the sensor and the control device.

6. The magnetic ore purification system of claim 5, wherein the at least one control mechanism operates on the feed material.

7. The magnetic ore purification system of claim 5, wherein the at least one control mechanism operates on the enriched material.

8. The magnetic ore purification system of claim 5, wherein the at least one control mechanism includes two devices, one of which operates on the feed material, the other of which operates on the enriched material.

9. The magnetic ore purification system of claim 5, wherein the at least one sensor includes an amperage sensor electrically connected to the at least one magnet.

10. The magnetic ore purification system of claim 2, and further comprising a waste removal port for removing the water and waste material from the elutriator.

11. The magnetic ore purification system of claim 1, and further comprising a device for introducing vibrational energy into the elutriator.

12. The magnetic ore purification system of claim 11, wherein the device for introducing vibrational energy includes at least one ultrasonic transducer.

13. A magnetic ore enrichment system for enriching magnetic ore concentration in a feed material, the system comprising:
an elutriator having a feed material port for introducing a feed material into the elutriator and an enriched material port for collecting am enriched material from the elutriator, wherein the magnetic ore concentration of the enriched material is greater than the magnetic ore concentration of the feed material;
an alternating current magnet for generating a low strength magnetic field within the elutriator; and
a device for introducing vibrational energy into the elutriator.

14. A magnetic ore purification system for enriching a concentration of magnetic ore in a feed material, the system comprising:
an elutriator having a feed material port for introducing a feed material into the elutriator, an enriched material port for collecting can enriched material from the elutriator, a water feed port for introducing water into the elutriator, a waste removal port for removing water and waste material from the elutriator, wherein the feed material port is opposite the water feed port so that the feed material and water flow through the elutriator in substantially countercurrent directions, and wherein the enriched material has a magnetic ore concentration that is greater than the concentration of magnetic ore and feed material;
two alternating current magnets disposed in spaced axial arrangement on the elutriator for producing low strength magnetic fields in the elutriator;
a process control system that includes an amperage sensor, at least one control device for regulating flow of material through the elutriator, and feedback control between the amperage sensor and the control device; and
wherein the system is capable of producing enriched material with a magnetic ore concentration of greater than about 95 percent by weight.

15. A magnetic ore enrichment process comprising:
introducing a feed material into an elutriator, wherein the feed material contains a first magnetic ore concentration;
introducing water into the elutriator so that the water mixes with the feed material and forms a slurry;
applying a first low strength magnetic field to the slurry;
subjecting the slurry to ultrasonic energy; and
collecting an enriched material having a second magnetic ore concentration that is greater than the first magnetic ore concentration.

16. The magnetic ore enrichment process of claim 15, wherein the second magnetic ore concentration is greater than about 98 percent by weight.

17. The magnetic ore enrichment process of claim 15, wherein the second magnetic ore concentration includes approximately 90 percent by weight of magnetic ore from the first magnetic ore concentration.

18. The magnetic ore enrichment process of claim 15, and further comprising flowing the feed material and the water through the elutriator in substantially countercurrent directions.

19. The magnetic ore enrichment process of claim 15, and further comprising applying a second low strength magnetic field to the slurry.

20. The magnetic ore enrichment process of claim 19, wherein the first magnetic field is applied with a constant amperage.

21. The magnetic ore enrichment process of claim 20, wherein the second magnetic field is applied with an amperage that is directly related to the rate at which the feed material is fed into the elutriator.

22. The magnetic ore enrichment process of claim 15, and further comprising grinding the feed material to finer than approximately 80 percent by weight less than 325 mesh.

23. The magnetic ore enrichment process of claim 15, and further comprising grinding the feed material to finer than approximately 98 percent by weight less than 500 mesh.

24. The magnetic ore enrichment process of claim 15, wherein the feed material has an average residence time in the elutriator of between about 1 and 20 minutes.

25. A magnetic ore enrichment process comprising:
introducing a feed material into an elutriator, wherein the feed material contains a first concentration of magnetic ore;
introducing water into the elutriator so that the water mixes with the feed material and forms a slurry;
applying a first low strength magnetic field to the slurry with an alternating current magnet; and
collecting an enriched material from the elutriator, wherein the enriched portion has a magnetic ore concentration of greater than about 95 percent by weight.

26. The magnetic ore enrichment process of claim 25, wherein the magnetic ore concentration of the enriched portion has greater than approximately 90 percent by weight of magnetic ore of the feed material.

27. The magnetic ore enrichment process of claim 25, and further comprising subjecting the slurry to vibrational energy.

28. The magnetic ore enrichment process of claim 25, wherein the feed material and water flow through the elutriator is in substantially countercurrent directions.

29. The magnetic ore enrichment process of claim 25, and further comprising applying a second low strength magnetic field to the slurry with a magnet.

30. The magnetic ore enrichment process of claim 29, wherein the second low strength magnetic field is applied by an alternating current magnet.

31. The magnetic ore enrichment process of claim 30, wherein the first magnetic field is applied at a constant amperage.

32. The magnetic ore enrichment process of claim 30, wherein the slurry in the elutriator has a level, and wherein amperage in the second magnetic field varies directly with the level of the slurry.

33. The magnetic ore enrichment process of claim 32, and further comprising the step of controlling the level of the slurry based on amperage monitored in the second alternating current magnet.

34. The magnetic ore enrichment process of claim 25, and further comprising the step of controlling flow of the feed material based on amperage monitored in the alternating current magnet.

35. The magnetic ore enrichment process of claim 25, and further comprising the step of controlling flow of the enriched material based on amperage monitored in the alternating current magnet.

36. The magnetic ore purification system of claim 3, wherein the enriched material is collected in an area above the water feed port in an area of countercurrent flow.

37. The magnetic ore purification system of claim 3, wherein the enriched material is collected in an area below the water feed port in an area outside of countercurrent flow.
